(19) United States
(12) Patent Application Publication
(10) Pub. No.: US 2024/0096611 A1
(43) Pub. Date: Mar. 21, 2024

(54) SYSTEMS AND METHODS FOR OBTAINING SAMPLES FOR ANALYSIS

(71) Applicant: DH Technologies Development Pte. Ltd., Singapore (SG)

(72) Inventors: Thomas R. COVEY, Newmarket (CA); Chang LIU, Richmond Hill (CA); Hui ZHANG, Winchester, MA (US)

(73) Assignee: DH Technologies Development Pte. Ltd., Singapore (SG)

(21) Appl. No.: 18/262,852

(22) PCT Filed: Feb. 8, 2022
(86) PCT No.: PCT/IB2022/051124

§ 371 Date: Jul. 25, 2023

Related U.S. Application Data
(60) Provisional application No. 63/147,280, filed on Feb. 9, 2021.

(51) Int. Cl. H01J 49/04

(52) U.S. Cl. CPC H01J 49/0431; H01J 49/0454

(57) ABSTRACT

A method of sampling an ejection of a sample from a liquid container includes disposing the liquid container adjacent an open port in-terface. The container includes a sampling port. The open port interface en-gages with the sampling port. The sample from the liquid container is eject-ed, through the sampling port, and into the open port interface. The sample is analyzed with a mass spectrometry device.

### CROSS-REFERENCE TO RELATED APPLICATION

This application is being filed on Feb. 8, 2022, as a PCT Patent International Application and claims the benefit of and priority to U.S. Provisional Application No. 63/147,280, filed on Feb. 9, 2021, which application is hereby incorporated herein by reference.

### BACKGROUND

An important goal in the analysis of substances is accurate real-time monitoring of reactions and other processes. Some attempts have been made, for example through the use of sample vials of microtiter plates. However, such attempts typically require the use of syringes or other means of undesirable physical contact with, and potentially contamination of, collected samples. They are also typically undesirably slow.

Faster analysis of reactions and other processes are available with mass spectrometry. Acoustic droplet ejection (ADE) has been combined with an open port interface (OPI) to provide a sample introduction system for high-throughput mass spectrometry. When an ADE device and OPI are coupled to a mass spectrometer, the system can be referred to as an acoustic ejection mass spectrometry (AEMS) system. The analytical performance (sensitivity, reproducibility, throughput, etc.) of an AEMS system depends on the performance of the ADE device and the OPI. The performance of the ADE device and the OPI depends on selecting the operational conditions or parameters for these devices. AEMS technology brings fast, precisely controlled, low-volume sampling to the direct high flow liquid transferring to the ESI without carry-over, to achieve this high-throughput analytical platform with high reproducibility, and wide compound coverage.

### SUMMARY

In one aspect, the technology relates to a method of sampling an ejection of a sample from a liquid container, the method including: disposing the liquid container adjacent an open port interface, wherein the container includes a sampling port; engaging the open port interface with the sampling port; ejecting the sample from the liquid container, through the sampling port, and into the open port interface; and analyzing the sample with a mass spectrometry device. In an example, engaging the open port interface with the sampling port includes opening at least one of a shutter or a septum. In another example, engaging the open port interface with the sampling port includes receiving the open port interface in the sampling port. In yet another example, engaging the open port interface with the sampling port further includes receiving the open port interface in the liquid container. In still another example, the method further includes flowing a curtain gas across the sampling port, prior to engaging the open port interface with the sampling port.

In another example of the above aspect, the method further includes ejecting a curtain gas from the sampling port, prior to engaging the open port interface with the sampling port. In an example, engaging the open port interface with the sampling port includes aligning the open port interface with the ejected curtain gas.

In another aspect, the technology relates to a system for aseptically obtaining sampling a sample for analysis, the system including: a liquid container containing the sample; an open port interface for receiving the sample; an acoustic ejection device for ejecting a droplet of the sample from the liquid container; and means for isolating an interior of the liquid container from an atmosphere surrounding the liquid container, wherein the means for isolating is configurable to allow ejection of the droplet from the liquid container and into the open port interface. In an example, the means includes a shutter positionable in a first open position and a second closed position. In another example, the shutter is positionable in the first open position upon engagement of the open port interface with at least a portion of the shutter. In yet another example, the means includes at least one of a septum and a gasket. In still another example, the means includes a curtain gas ejector directed proximate a sampling port.

In another example of the above aspect, the open port interface is positonable relative to the liquid container. In an example, the liquid container includes a conduit, and wherein the sample flows continuously through the conduit liquid container. In another example, the open port interface is configured to contact the sample.

In another aspect, the technology relates to a method of aseptically sampling a droplet of a fluid sample, the method including: isolating, from a surrounding atmosphere, the fluid sample in a liquid container; aligning a port of the liquid container with an open port interface; and ejecting the droplet into the open port interface while maintaining the isolation of the fluid sample. In an example, isolating the fluid sample includes directing a gas curtain across the port of the liquid container. In another example, the method further includes penetrating the port with the open port interface. In yet another example, the method further includes sealingly engaging the port with the open port interface. In still another example, sealingly engaging the port includes penetrating at least one of a septum or positionable shutter with the open port interface.

### BRIEF DESCRIPTION OF THE DRAWINGS

FIG. 1 is a schematic view of an example mass analysis system combining acoustic droplet ejection (ADE) with an open port interface (OPI) sampling interface and electrospray ionization (ESI) source.

FIG. 2 depicts a schematic view of a mass analysis system utilized in conjunction with a well plate.

FIGS. 3A-3C depict schematic views of mass analysis systems utilized in conjunction with different types of continuous flow systems.

FIGS. 4A and 4B depict devices for isolation of samples in liquid containers.

FIGS. 5A and 5B depict other devices for isolation of samples in liquid containers.

FIGS. 6A-6C depict other devices for isolation of samples in liquid containers.

FIG. 7 depicts another device for isolation of a sample in a liquid container.

FIGS. 8A and 8B depict methods of aseptically sampling a sample ejected from a liquid container.

FIG. 9 depicts an example of a suitable operating environment in which one or more of the present examples can be implemented.

### DETAILED DESCRIPTION

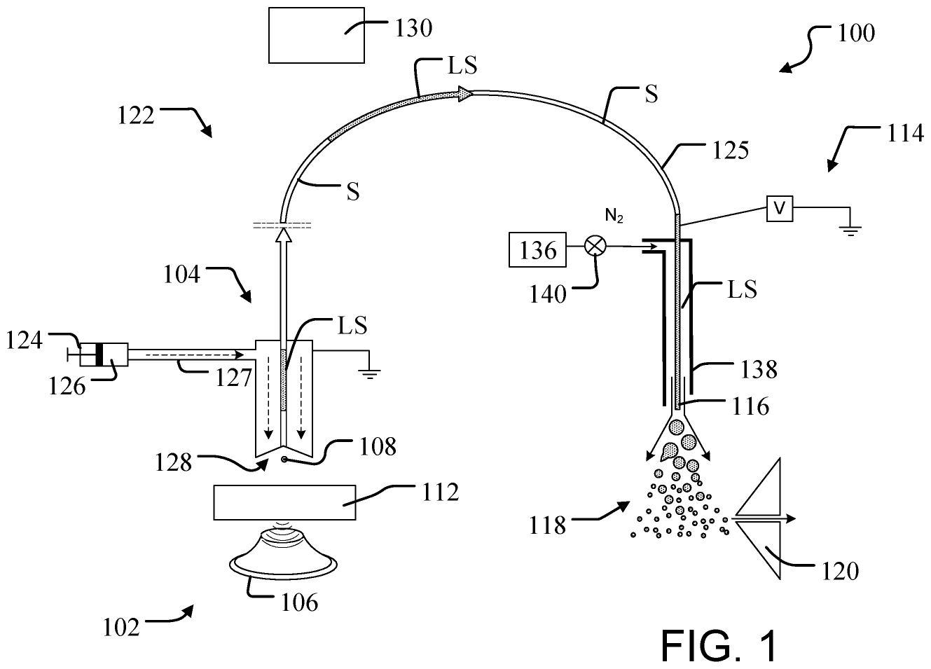

FIG. 1 is a schematic view of an example system 100 combining an ADE 102 with an OPI sampling interface 104 and ESI source 114. The system 100 may be a mass analysis instrument such as a mass spectrometry device that is for ionizing and mass analyzing analytes received within an open end of a sampling OPI. Such a system 100 is described, for example, in U.S. Pat. No. 10,770,277, the disclosure of which is incorporated by reference herein in its entirety. The ADE 102 includes an acoustic ejector 106 that is configured to eject a droplet 108 from a liquid container 112 (depicted schematically) into the open end of sampling OPI 104. As shown depicted in the following figures, different types of liquid containers 112, such as well plates and continuous flow systems, may be utilized. As shown in FIG. 1, the example system 100 generally includes the sampling OPI 104 in liquid communication with the ESI source 114 for discharging a liquid containing one or more sample analytes (e.g., via electrospray electrode 116) into an ionization chamber 118, and a mass analyzer detector (depicted generally at 120) in communication with the ionization chamber 118 for downstream processing and/or detection of ions generated by the ESI source 114. Due to the configuration of the nebulizer probe 138 and electrospray electrode 116 of the ESI source 114, samples ejected therefrom are in the gas phase. A liquid handling system 122 (e.g., including one or more pumps 124 and one or more conduits 125) provides for the flow of liquid from a solvent reservoir 126 to the sampling OPI 104 and from the sampling OPI 104 to the ESI source 114. The solvent reservoir 126 (e.g., containing a liquid, desorption solvent) can be liquidly coupled to the sampling OPI 104 via a supply conduit 127 through which the liquid can be delivered at a selected volumetric rate by the pump 124 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. As discussed in detail below, the flow of liquid into and out of the sampling OPI 104 occurs within a sample space accessible at the open end such that one or more droplets 108 can be introduced into the liquid boundary 128 at the sample tip and subsequently delivered to the ESI source 114.

The system 100 includes an ADE 102 that is configured to generate acoustic energy that is applied to a liquid contained within the liquid container 112 that causes one or more droplets 108 to be ejected from the liquid container 112 into the open end of the sampling OPI 104. A controller 130 can be operatively coupled to the ADE 102 and can be configured to operate any aspect of the ADE 102. This enables the ADE 106 to inject droplets 108 into the sampling OPI 104 as otherwise discussed herein substantially continuously or for selected portions of an experimental protocol by way of non-limiting example. Controller 130 can be, but is not limited to, a microcontroller, a computer, a microprocessor, or any device capable of sending and receiving control signals and data. Wired or wireless connections between the controller 130 and the remaining elements of the system 100 are not depicted but would be apparent to a person of skill in the art.

As shown in FIG. 1, the ESI source 114 can include a source 136 of pressurized gas (e.g. nitrogen, air, or a noble gas) that supplies a high velocity nebulizing gas flow to the nebulizer probe 138 that surrounds the outlet end of the electrospray electrode 116. As depicted, the electrospray electrode 116 protrudes from a distal end of the nebulizer probe 138. The pressured gas interacts with the liquid discharged from the electrospray electrode 116 to enhance the formation of the sample plume and the ion release within the plume for sampling by mass analyzer detector 120, e.g., via the interaction of the high speed nebulizing flow and jet of liquid sample (e.g., analyte-solvent dilution). The liquid discharged may include discrete volumes of liquid samples LS received from the liquid container 112. The discrete volumes of liquid samples LS are typically separated from each other by volumes of the solvent S (hence, as flow of the solvent moves the liquid samples LS from the OPI 104 to the ESI source 114, the solvent may also be referred to herein as a transport liquid). The nebulizer gas can be supplied at a variety of flow rates, for example, in a range from about 0.1 L/min to about 20 L/min, which can also be controlled under the influence of controller 130 (e.g., via opening and/or closing valve 140).

It will be appreciated that the flow rate of the nebulizer gas can be adjusted (e.g., under the influence of controller 130) such that the flow rate of liquid within the sampling OPI 104 can be adjusted based, for example, on suction/aspiration force generated by the interaction of the nebulizer gas and the analyte-solvent dilution as it is being discharged from the electrospray electrode 116 (e.g., due to the Venturi effect). The ionization chamber 118 can be maintained at atmospheric pressure, though in some examples, the ionization chamber 118 can be evacuated to a pressure lower than atmospheric pressure.

It will also be appreciated by a person skilled in the art and in light of the teachings herein that the mass analyzer detector 120 can have a variety of configurations. Generally, the mass analyzer detector 120 is configured to process (e.g., filter, sort, dissociate, detect, etc.) sample ions generated by the ESI source 114. By way of non-limiting example, the mass analyzer detector 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer,” authored by James W. Hager and J. C. Yves Le Blanc and published in Rapid Communications in Mass Spectrometry (2003; 17: 1056-1064); and U.S. Pat. No. 7,923,681, entitled “Collision Cell for Mass Spectrometer,” the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements can be included in the system 100 including, for example, an ion mobility spectrometer (e.g., a differential mobility spectrometer) that is disposed between the ionization chamber 118 and the mass analyzer detector 120 and is configured to separate ions based on their mobility difference between in high-field and low-field). Additionally, it will be appreciated that the mass analyzer detector 120 can comprise a detector that can detect the ions that pass through the analyzer detector 120 and can, for example, supply a signal indicative of the number of ions per second that are detected.

As noted above, different types of liquid containers may be utilized with the aseptic sampling systems described herein. Examples of such containers include individual wells disposed in well plates, as well as continuous flow systems where samples are ejected from a fluid conduit. Examples of these types of systems are described below.

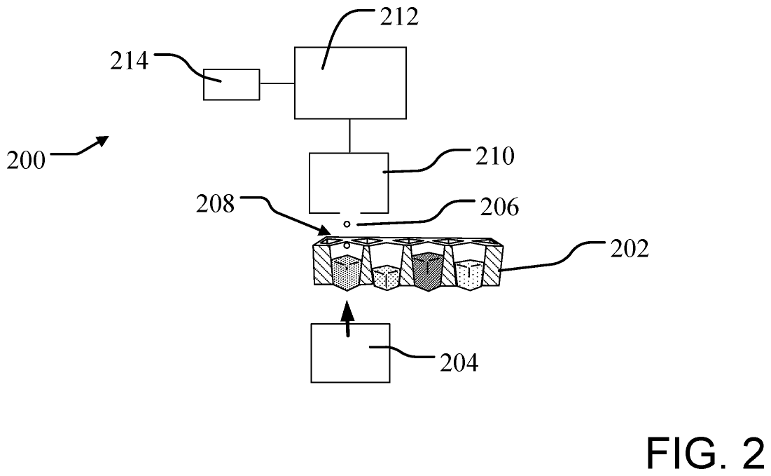

FIG. 2 depicts a schematic view of a mass analysis system 200 utilized in conjunction with a well plate 202. The mass analysis system 200 may be the system depicted in FIG. 1, or another type of mass analysis system. An ADE 204 enables contactless ejection of droplets 206 from individual wells 208 of the well plate 202. The droplets 206 are received in a port 210 (such as an OPI), and subsequently analyzed by a mass analyzer 212. The mass analysis system 200 may include or be communicatively coupled to one or more processors or controllers 214. The controller 214 is configured to receive, process, and send suitably-configured signals adapted to control the various components of the mass analysis system 200.

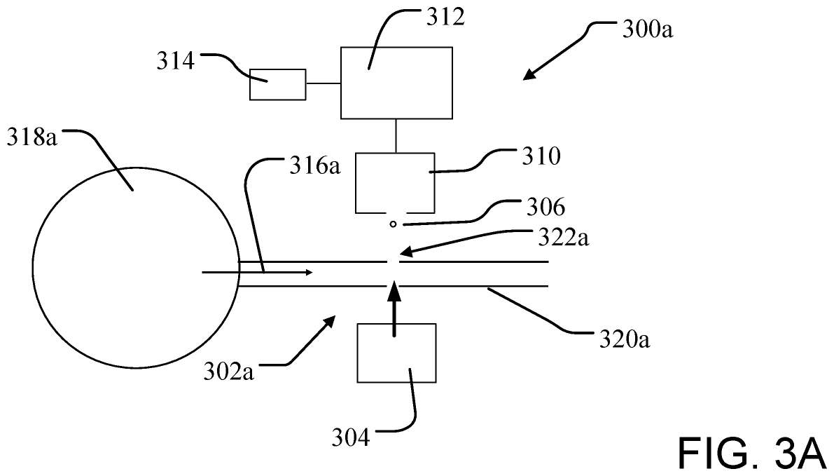

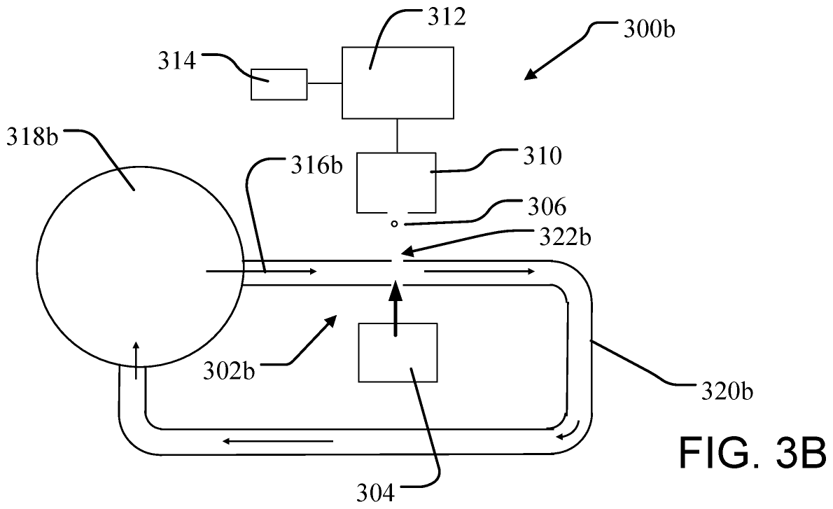

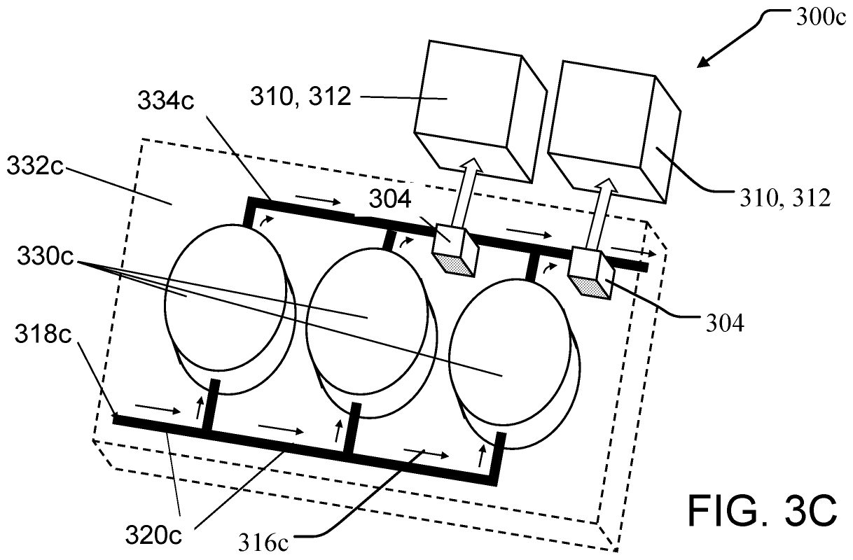

FIGS. 3A-3C depict schematic views of mass analysis systems 300a-c utilized in conjunction with different types of continuous flow systems. Shared aspects of the systems 300a-c of FIGS. 3A-3C are described first concurrently. As with the example system 200 of FIG. 2, the systems 300a-c include a contactless ejector such as an ADE 304 enables contactless ejection of droplets 306 from a liquid container 302 (variants thereof being described in more detail below). The droplets 306 are received in a port 310 (such as an OPI), and subsequently analyzed by a mass analyzer 312. The mass analysis systems 300a-c may include or be communicatively coupled to one or more processors or controllers 314 (not depicted in FIG. 3A).

Turning to the specific example of FIG. 3A, the liquid container 302a is a fluid conduit 320a that contains an open (non-circulating) sample stream 316a. The stream 316a is provided by one or more sources 318a so as to pass within operating proximity of the ADE 304. There, one or more sample droplets 306 may be ejected by contactless ejection through the provision of a suitably-configured aperture 322a within the conduit 320a. Once one or more sample droplets 306 have been ejected, non-removed portions of the sample stream 316a can be discharged from the system into a suitable receptacle, drain, pool, or stream, etc.

Turning to FIG. 3B, the liquid container 302b is a fluid conduit 320b that contains an open (circulating) sample stream 316b. The stream 316b is provided by one or more sources 318b so as to pass within operating proximity of the ADE 304. At the ADE 304, one or more sample droplets 306 may be ejected by contactless ejection through the provision of a suitably-configured aperture 322b within the conduit 320b. Non-sampled portions of the sample stream 316b may be returned to the source 318b, without losing fluids which may be material to continuing reaction(s) within the source 318b. Sampled droplets 306 may be returned to the same source 318a, other source(s), or discarded.

The systems 300a, 300b of FIGS. 3A and 3B may include any liquid and/or other types of fluid streams 316a, 316b for which it is desired to remove samples for mass analysis and other forms of analysis. These may include for example samples of chemical reactions as they are in progress (e.g., real-time reaction monitoring), such as reactions incubated in the sources 318a, 318b, or in systems in which reagents are added or refreshed continuously in incubation systems, or in which reagents and/or intermediate products of reactions are passed through conduits 320a, 320b. In other examples, sample streams may be provided in the forms of natural or artificial conduits such as rivers or other natural fluid channels, pipelines, fluid transfer tubing, etc. The liquid containers 302a, 302b may be considered “continuous” for the purposes of this disclosure, which encompasses and includes the terms “continual” and “intermittent” such that continual and intermittent sample streams are considered continuous for purposes of this disclosure. Thus, it may be seen, for example, that sample sources 318a, 318b can include reaction reservoirs, natural and/or artificial streams, and/or any other sources of piped, channeled, or other types of fluid transfer streams.

An additional example system 300c is depicted in FIG. 3C, where conduits 320c are configured to deliver reagent, solvent or other carrier stream(s) 316c provided by any one or more sources 318c. The source 318c may be a source as depicted in FIG. 3A or 3B. The system 300c may further include any one or more cells or reaction chambers 330c of an “organ” or “tissue” “on a chip” or reaction chamber carrier set, for example, and invitro cell culture chip, 332c, wherein may be placed cellular tissue or other substances or components for proposed chemical and/or biological reaction(s). Once a reaction has been initiated, and has progressed to a desired stage, fluid conduits 334c can carry some or all of the reagents, reactants, and/or products of the reaction(s) into operating proximity of one or more contactless sample ejector(s) 304 (e.g., ADEs), for ejection of one or more sample droplets and introduction of the sample droplets to port(s) 310 for analysis by analyzer(s) 312.

FIG. 3C depicts a system 300c based on the basic system configurations depicted in FIGS. 3A and 3B. As will be appreciated by those skilled in the relevant arts, in further examples, any desired numbers of conduits, streams, reaction cells or chambers, ejectors, and analyzers can be provided in various examples, and sample droplets can be ejected from any one or more desired points of the system, including any portion(s) of conduits and/or chambers or cells. It will further be appreciated by such persons that reactions may be instigated in any desired portions of the systems, including within any up- and/or down-stream conduits, and or chamber(s), and/or portions thereof. For example, some or all of the walls of conduit(s) may be lined with any reactants, reagents, cells, etc., to create desired single or multi-stage reactions at any desired points in the systems, and sample droplet(s) may be removed from any such desired points.

For the systems depicted in FIGS. 2-3C, the use of ADE allows for ejection of very low volumes of fluids (typically nanoliters or picoliters) without physical contact from the sample source (e.g., the wells of FIG. 2, or the continuous streams of FIGS. 3A-3C). Such technologies can be used to focus acoustic energy at selected points in wells or fluid streams in order to eject small droplets comprising substances such as transfer proteins, high molecular weight DNA, and living cells, without damage or loss of viability. In some examples, such ejectors can be configured for contactless ejection of pluralities of droplets as selectable ejection rates. Corresponding results may be provided through the use of piezoelectric devices.

As such, example reactions instigated in wells, reservoirs, chambers, and/or conduits can be monitored over time at higher or lower sampling rates or frequencies, and with sufficient sample material to support accurate and efficient analysis. Sampling rates can be set at any desired set or variable frequencies, volumes, and/or masses, depending upon the nature of the reaction(s) to be monitored, the capabilities and characteristics of the contactless ejector(s), including operational frequencies and output power or energy levels, in addition to focusing and other characteristics, the nature(s) of the systems and components thereof, and the objects of the analysis. The quality and likely success of acoustic ejections in accordance with various aspects and examples of the technologies can be improved through precise (and in some embodiments, real-time) adjustment of parameters of acoustic waveforms (e.g. focus, energy, and duration of the acoustic pulse) used for ejection. Parameters of acoustic waveforms can be dependent on the composition and liquid levels of the solvent, reagent, or other stream(s) and may be used to control the frequency, mass, and/or volume of ejected particles. For example, composition(s) of streams can be controlled for predictability and/or stability during reactions, incubations, and/or other processes, so that exact ejection parameters can be set and applied. In some examples, sample droplets can be ejected at 1-500 samples per minute. For some applications, including for example “organ on a chip” applications, sampling rates of 1-180 samples per minute per ejector may be utilized. As will be understood by those skilled in the art, sampling rates can be varied by changing the rates implemented by each ejector, and/or by increasing or decreasing the numbers of ejectors employed in a system.

The systems depicted in FIG. 2-3C display high throughput and accuracy. The contactless ejectors (such as ADEs) utilized in systems such as depicted in FIG. 2 are particularly advantageous over syringe-based systems, as they reduce the likelihood of cross-contamination between wells of a well plate. With regard to continuous flow systems, systems such as depicted in FIGS. 3A-3C, samples may be ejected at particular times during a reaction, thus preventing residual samples potentially present in a syringe from an earlier extraction from compromising the results. Thus, one advantage is that the ADE may eject droplets from a fluid sample without contact between the ADE with the sample, which can help prevent introduction of contaminants. Another advantage is that the high throughputs available with ADE may enable rapid sampling of entire liquid containers. Further, and in the context of continuous stream systems, the rapid ejections enable accurate sampling of fluids as those fluids flow in a liquid conduit, even at fairly high flow rates. Additionally, the droplets themselves are ejected at a very high velocity, which reduces exposure time of the droplet to the surrounding atmosphere. Since the rate of ejection is very high, samples that are contained within a closed environment (e.g., a closed conduit or sample well), need only be exposed to the surrounding atmosphere for a very limited period of time, thereby reducing potential exposure of the sample (and any ongoing reactions therein) to contaminants that may be in the atmosphere. This may be particularly advantageous if the reactions occurring in the sample (e.g., in an organ on chip, or continuous flow application) are ongoing and should avoid contaminant exposure.

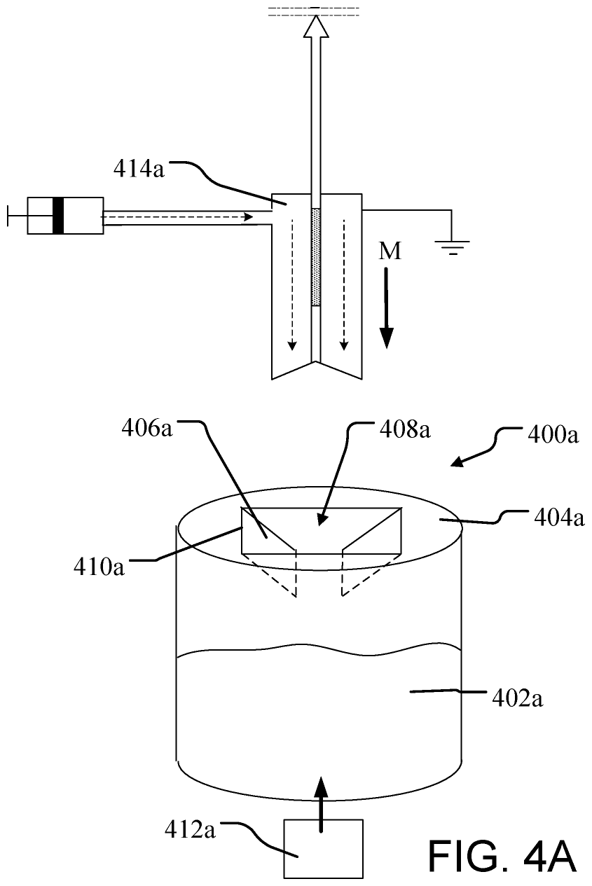

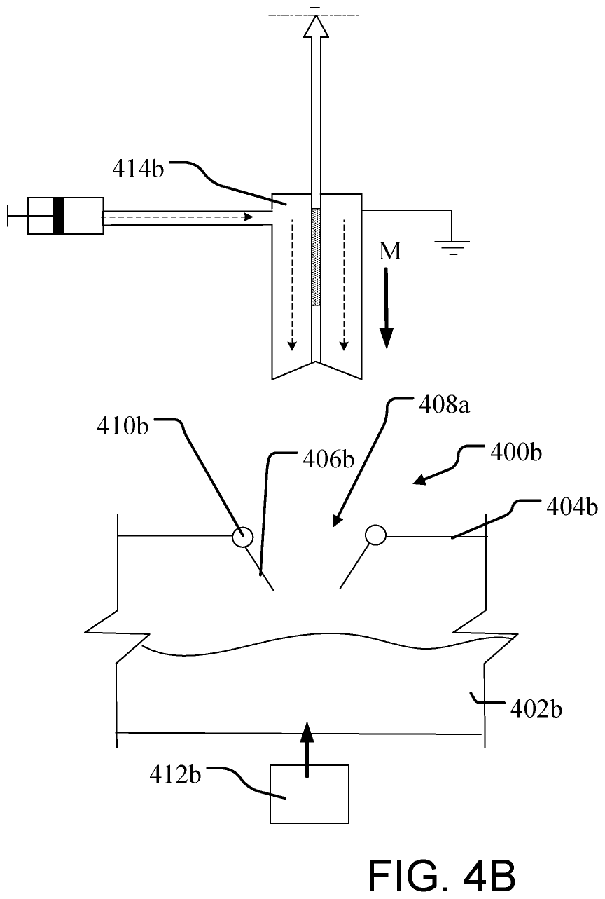

Thus, while contactless ejectors are advantageous for preventing contamination while taking of the sample, protecting the sample from contamination after ejection may be advantageous. A system that utilizes a complement of technologies can thus perform complete or near complete aseptic sampling, although many of the technologies described further herein have individual utility for particular applications. Such technologies to further isolate the samples from the surrounding environment are described below. These technologies may be applied to both static samples (such as those in a well plate, e.g., as depicted in FIG. 2), as well as flowing samples (such as those in a fluid conduit, e.g., as depicted in FIGS. 3A-3C). The technologies may be used to isolate the fluid samples and/or ejected droplets during and after ejection. Further, the environments in which the samples are maintained may further isolate the samples prior to ejection. This helps maintain sterility of the sample and/or droplet at all stages, leading to more accurate analysis, uncompromised reactions, etc. When used in conjunction with ADEs or other contactless ejectors such as described above, the isolation technologies described herein aid in aseptic sampling from liquid containers. These isolation technologies may include physical structures on the container (e.g., movable shutters, penetrable septa, etc.) that open and close as required during the sampling process; sterile air or other gas flows to isolate the samples and/or droplets; sealed interfaces between the container and the sampling port; sampling ports that sample from below an upper, exposed surface of a sample; combinations of these technologies; and other similar technologies. In the descriptions that follow, shared features and components may be described generally with a number only (e.g., liquid container 400), while specific examples are depicted in the figures and described in the specification with a number and letter (e.g., FIG. 4A depicts well 400a, FIG. 4B depicts fluid conduit 400b, etc.). Further, while certain features of isolation elements are depicted in conjunction with, for example, a liquid container in the form of a well, such features may be incorporated into the liquid container in the form of a fluid conduit, and vice versa.

FIGS. 4A and 4B depict devices for isolation of a sample 402 in a liquid container 400. More specifically, FIG. 4A depicts a top perspective view of a well 400a of a well plate, while FIG. 4B depicts a side section view of a fluid conduit 400b. Each liquid container 400 contains a sample 402, which may be a generally static sample 402a, in the case of the well 400a, or a flowing sample 402b, in the case of the fluid conduit 400b. In examples, the sample 402 does not occupy the entire volume of the liquid container 400, so as to avoid unintentional leaking of the sample 402 therefrom (e.g., out of a sampling port or opening 408 thereof). Both liquid containers 400 define a substantially closed interior volume. In the case of the well 400a, the interior volume is closed by a lid or cap 404a, while the fluid conduit 400b is closed by one or more walls 404b of the conduit 400b itself. The isolation element includes one or more shutters 406 that selectively close an opening 408 in the exterior of the liquid container 400. The shutters 406 may be configured as required or desired for a particular application to be positioned in a first, open position (depicted) and a second, closed position. In the example of FIG. 4A, the shutters 406a may be connected to the lid or cap 404a via a living hinge 410a. In FIG. 4B, however, a mechanical hinge 410b (e.g., having a tube/leaf and hinge pin configuration) may be utilized. Either type of shutter 406 may be biased to return to a closed position, either due to the hinge material itself or through use of a biasing element such as a spring (leaf, torsion, etc.) or a resilient biasing element. In another example, the shutter 406 may be mechanized to open only during an ejection operation. In other examples, the shutter 406 may include a magnet or electromagnet that responds to the proximity of a magnet on the OPI 414. In examples, mechanized shutters may be advantageous when the OPI 414 is disposed remote from the liquid container 400 during an ejection operation. The opening 408 and shutter 406 may be disposed opposite an ADE 412 or other contactless ejector, which may eject one or more droplets from the sample 402 when the shutter 406 is open. Passive shutters, which may open when acted upon by an exterior force, may be more appropriate for use in systems that utilize an OPI that is positionable relative to the liquid container 402. For example, the OPI 414 depicted in FIGS. 4A and 4B moves M toward the liquid container 400, and contact between the OPI 414 and the shutter 406 opens the shutter 406. This allows the ADE 412 to eject one or more droplets from the interior volume of the fluid container 400. This configuration may also provide an added advantage of sealing the opening 408 from contaminants that may be present in the surrounding atmosphere and that might otherwise intrude during ejection procedures.

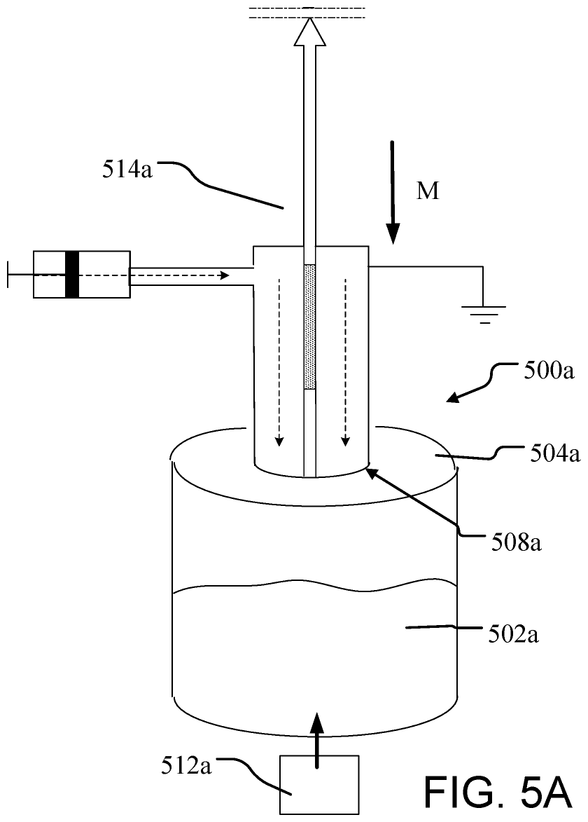

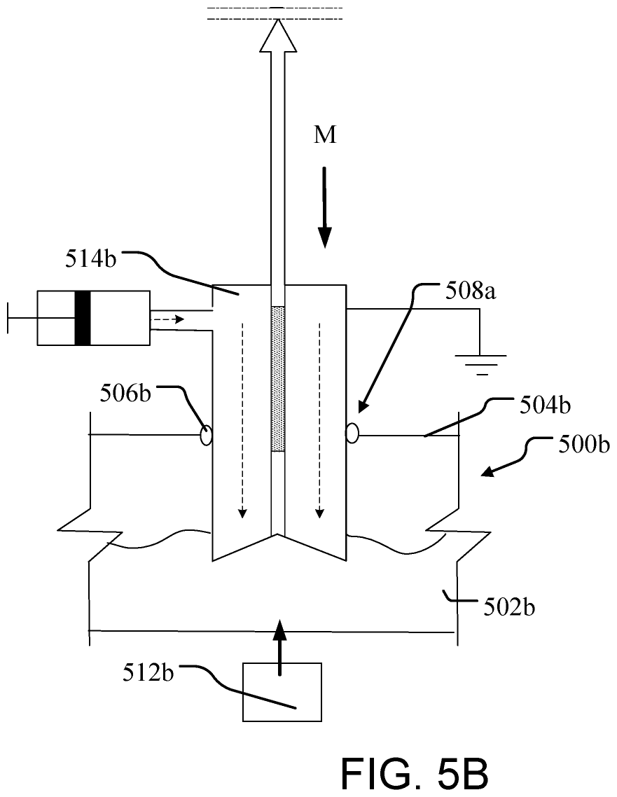

FIGS. 5A and 5B depict another device for isolation of a sample in a liquid container 500. As with previous configurations, FIG. 5A depicts a top perspective view of a well 500a of a well plate, while FIG. 5B depicts a side section view of a fluid conduit 500b. Each liquid container 500 contains a sample 502, which may be a generally static sample 502a, in the case of the well 500a, or a flowing sample 502b, in the case of the fluid conduit 500b. In examples, the sample 502 does not occupy the entire volume of the liquid container 500, so as to avoid undesirable leaking of the sample 502 therefrom. Both liquid containers 500 define a substantially closed interior volume. Each interior volume is closed by a wall 504 that includes a flexible or resilient septum 506. The septum 506 defines an opening or sampling port 508 that may conform to an outer surface of an OPI 514. When the OPI 514 is moved into contact with the septum 506, a tip thereof penetrates the opening 508, and may receive a droplet discharged via the ADE 512 or other contactless ejector. In the configuration of FIG. 5A, the OPI 514a need only be moved M until the opening 508a of the septum 504a surrounds the OPI 514a. Engagement between the OPI 514a and the septum 504a may be further improved by tapering an outer wall of the OPI 514a, such that a proper seal may be maintained. Such tapering may be utilized on the other examples of OPIs described herein, as required or desired. Thereafter, the ADE 512a may eject one or more droplets into the OPI 514a. In other examples, if the OPI 514a is inserted to a depth so as to contact the sample 502a, the aspiration force may be sufficient to draw the sample 502a into the OPI 514a (e.g., obviating the need for the ADE 512a. In this and the following examples, if the OPI contacts or is immersed in the sample, transport liquid need not be utilized (or the flow thereof may be significantly reduced), thus eliminating or at least reducing the likelihood of sample contamination.

In the example of FIG. 5B, the OPI 514b penetrates the septum 506b and continues to be moved M or advanced towards the liquid sample 502b. For examples where the OPI 514b is not immersed in the sample 502b, the ADE 512b may eject droplets of the sample 502b directly into the OPI 514b. In examples where immersion occurs, the ADE 512b need not be actuated and the aspiration force through the sampling port 514b (generated by the discharge from the nebulizer capillary, as depicted in FIG. 1) may be sufficient to draw discrete samples for testing from the sample stream 502b. By immersing the OPI 514b in the sample 502b, the likelihood of aspirating contaminants is reduced or eliminated.

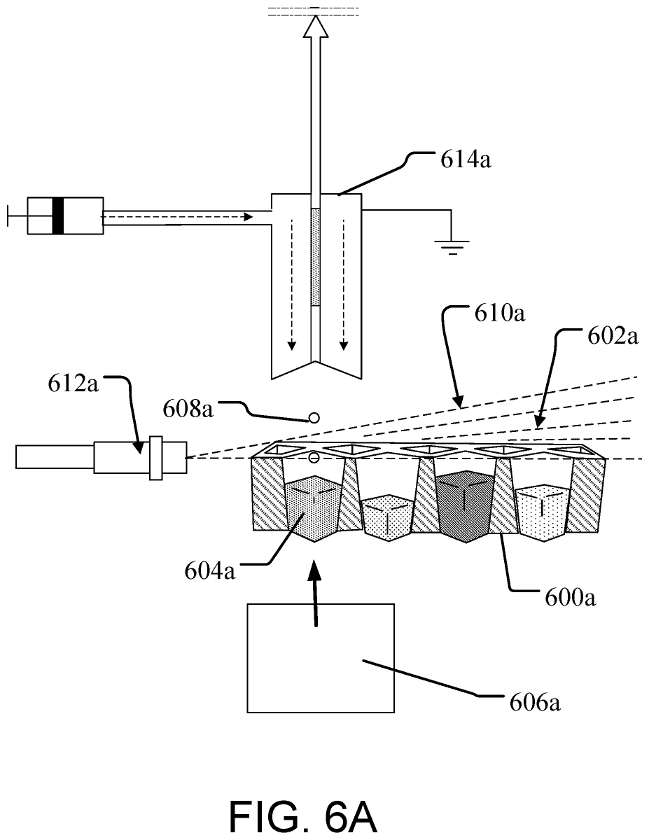

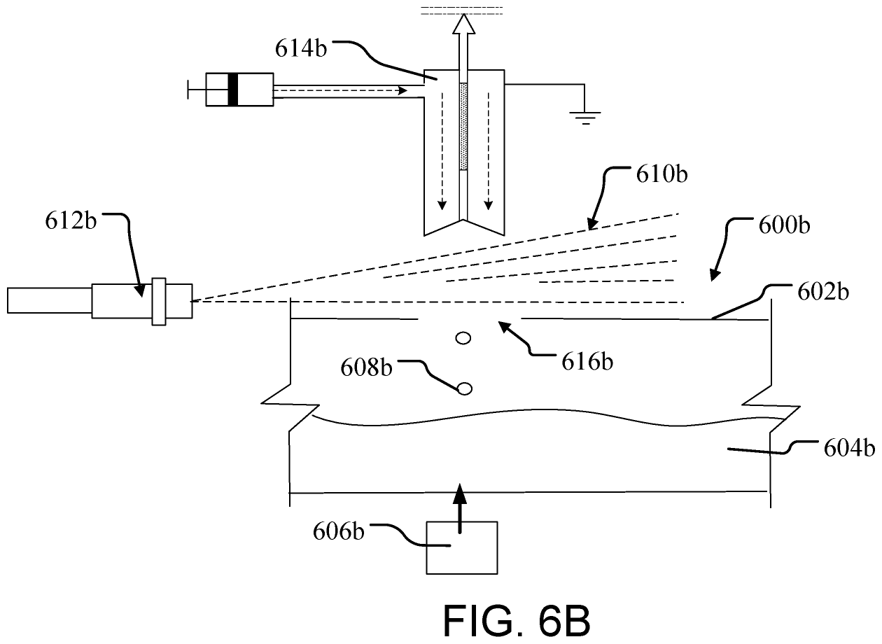

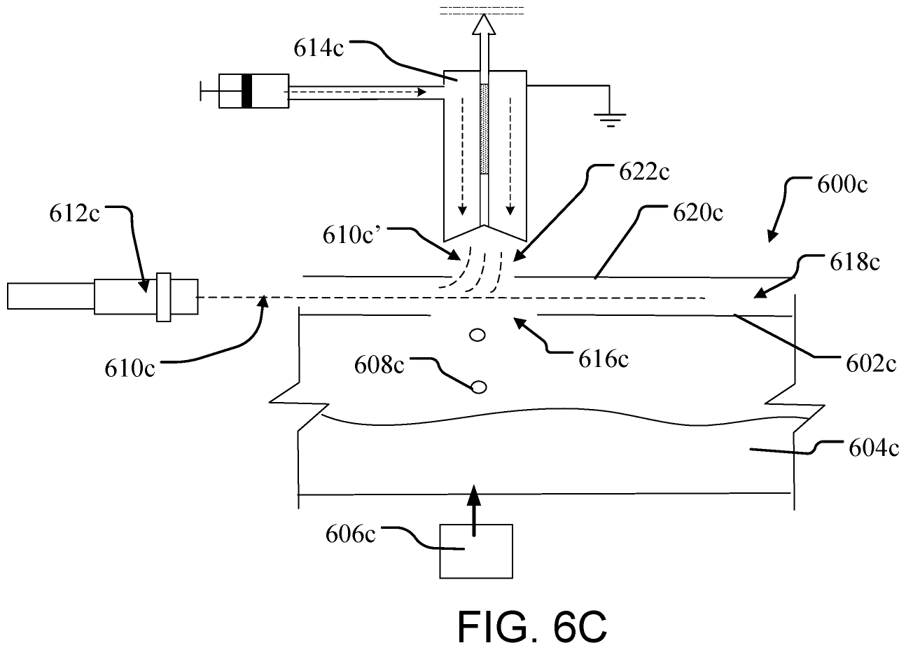

FIGS. 6A-6C depict other devices for isolation of samples 602 in liquid containers 600. FIG. 6A depicts a top perspective view of a well plate 600a, while FIGS. 6B and 6C depict a side section view of a fluid conduit 600b, 600c. With regard to FIG. 6A, the well plate 600a defines a plurality of wells 602a, each of which contains a sample 604a. An ADE 606a is used to eject droplets 608a from each well 602a and into an OPI 614a. Each well 602a of the well plate 600a may be isolated from a surrounding atmosphere by a curtain of air or other sterile gas 610a, which may be ejected from a nozzle 612a disposed adjacent the well plate 600a. The curtain gas 610a may be ejected in a flat fan configuration, so as to flow substantially parallel to an upper surface of the well plate 600a. The flow of curtain gas 610a is depicted in this and other examples herein schematically, and from a single direction. Flow of the gas (or multiple flows from multiple directions) may be directed and otherwise controlled so as to limit or avoid altering a trajectory of the ejected droplet 608a. An isolation device utilizing a curtain gas 610a may be used in conjunction with other isolation devices depicted above. For example, the shutter-based isolation device may be particularly useful, in that the ejection of the curtain gas 610a may be controlled so as to operate when the shutter for each well is open, thus maintaining sample isolation of a well, even when the shutter on that well is open. Due to the flat fan configuration of the curtain gas 610a and the high ejection speed of each droplet 608a, the curtain gas 610a will not adversely affect flight of the droplet 608a towards the OPI 614a.

With regard to FIG. 6B, the fluid conduit 600b includes one or more walls 602b, at least one of which may be defined by a sampling port or opening 616b. A sample 604b continuously flows through the conduit 600b. An ADE 606b is used to eject droplets 608a from the sample 604b and into the OPI 614b. A curtain of air or other sterile gas 610b, which may be ejected from a nozzle 612b, isolates the interior thereof from the surrounding atmosphere. The curtain gas 610b may be ejected in a flat fan configuration, so as to flow substantially parallel to an outer surface of the fluid conduit 600b. Droplets 608b may be ejected from the flow of the liquid sample 604b, through the curtain gas 610b. Due to the flat fan configuration of the curtain gas 610b and the high ejection speed of each droplet 608b, the curtain gas 610b will not adversely affect flight of the droplet 608b towards the OPI 614b.

FIG. 6C depicts a variation of the curtain gas isolation system of FIG. 6B. In FIG. 6C, the fluid conduit 600c includes one or more inner walls 602c, at least one of which may be defined by an inner sampling port or opening 616c. An ADE 606c is used to eject droplets 608c from a continuously flowing sample 604c and into an OPI 614c. A curtain of air or other sterile gas 610c, e.g., from a nozzle 612c, is ejected into a space 618c defined by the inner wall 602c and an outer wall 620c surrounding the inner wall 602c. The outer wall 620c may also define an outer opening or port 622c that is substantially aligned with the inner sampling port or opening 616c. A portion 610c′ of the curtain gas 610c may be ejected through the outer opening or port 622c during ejection of the droplets 608c, thus keeping the droplets 608c substantially surrounded by the isolating curtain gas 610c′ during ejection thereof into the OPI 614c.

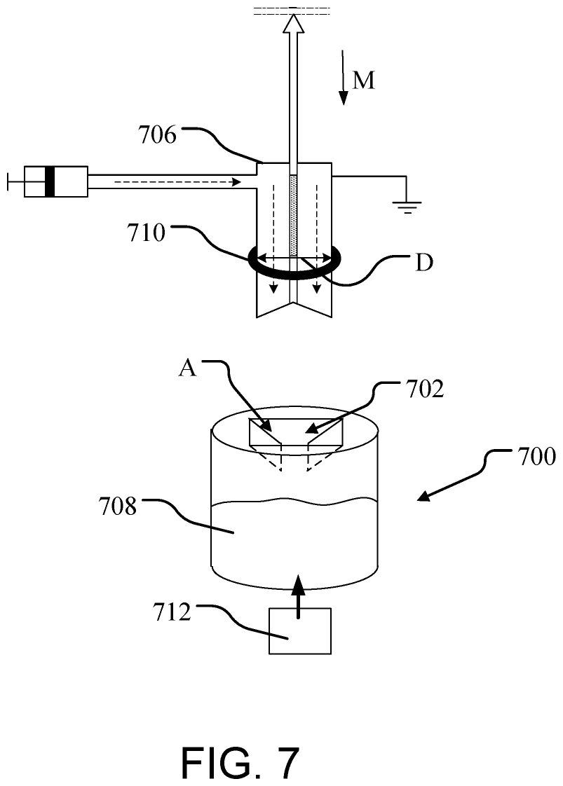

FIG. 7 depicts another device for isolation of a sample 702 in a liquid container 700. While the previous devices for isolation are disposed primarily on the liquid containers themselves, the OPI may include one or more devices for isolating the sample from a surrounding environment. In the depicted configuration, the liquid container 700 includes a shutter 702 such as depicted in FIG. 4A. The shutter 702 may define an area A having at least two dimensions, e.g., a length and a width. While the shutter 702 may remain biased into a closed position when the OPI 706 is not engaged with the liquid container 700, the shutter 702 opens during engagement. Isolation of the sample 708 disposed therein may be enhanced by installing (e.g., via movement I) a gasket, washer, or O-ring 710 about the OPI 706. A diameter D of the O-ring 710 may result in an area defined by the OPI 706 and the surrounding O-ring 710 that is greater than that of the exposed area A associated with the shutter 702. This helps ensure isolation of the sample 708 as the shutter 702 remains open during ejection of a droplet by the ADE 712. Although this configuration is depicted in conjunction with a sampling well, an O-ring may be disposed about an OPI that is used to receive a sample ejected from a fluid conduit. Indeed, in certain examples of a sample contained in a fluid conduit, an OPI may be permanently inserted into the conduit, with the OPI tip disposed above or within the sample liquid, and an O-ring may be used to seal the penetration.

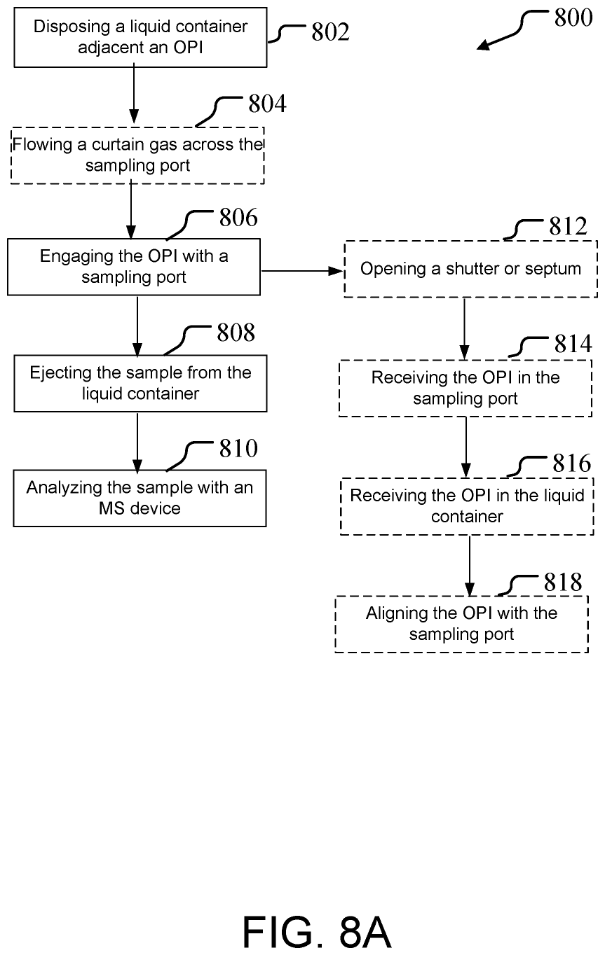

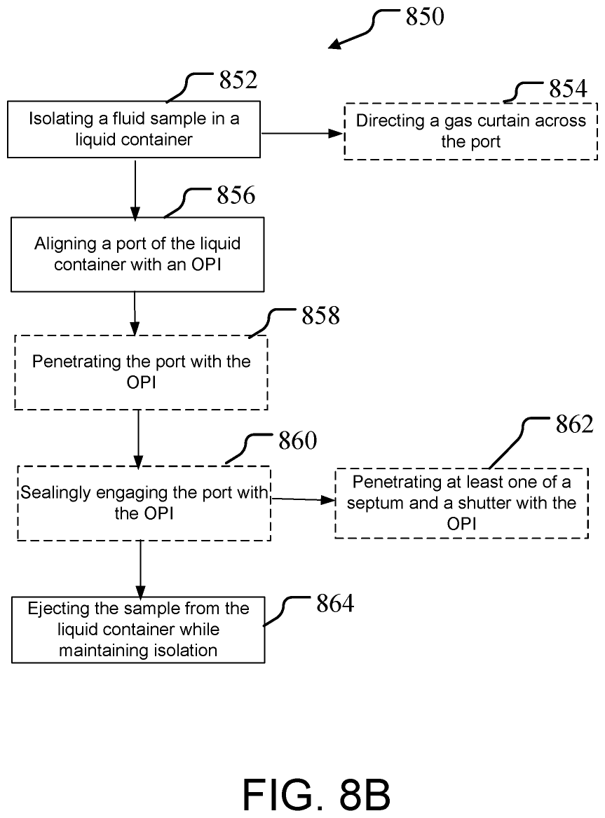

FIGS. 8A and 8B depict methods of aseptically sampling a droplet of a sample ejected from a liquid container. Beginning with FIG. 8A, that method 800 begins with disposing the liquid container adjacent an OPI, operation 802. As noted herein, the liquid container may be a well of a well plate or a liquid conduit that receives a constant flow of a sample. The liquid container includes a sampling port. In particular configurations, the method 800 may include flowing a curtain gas across the sampling port, operation 806. This may be performed prior to operation 806, where the OPI is engaged with the sampling port, so as to ensure isolation of the sample from the surrounding environment. Examples of such engagement are described beginning in operation 812, which includes opening at least one of a shutter or a septum. In the case of a shutter, opening may be performed by a motorized actuator, due to activation or deactivation of a magnetic force, or by physical engagement between the OPI and the shutter. For example, operation 814 contemplates receiving the OPI in the sampling port. In the case of a septum, the OPI opens the septum by penetrating same. In either case, penetration of the OPI may terminate once the OPI is positioned to receive an ejected droplet. In other examples, the OPI may be received in the liquid container, e.g., as far as desired to enable contact between the OPI and the liquid sample itself, operation 816. Such a configuration is depicted, e.g., in FIG. 5B. In examples of the method 800 where optional operation 804 is performed, engaging the OPI with the sampling port may include aligning the OPI with the sampling port, operation 818, and the curtain gas ejected therefrom, e.g., as depicted in FIG. 6C. The method 800 continues with ejecting the sample in the form of a droplet, from the liquid container, operation 806. The ejected sample droplet may pass through the sampling port and into the OPI. Thereafter, operation 810, analyzing the sample with a mass spectrometry device, is performed.

In FIG. 8B, the method 850 begins with isolating, from a surrounding atmosphere, the fluid sample in a liquid container, operation 802. In an example, isolating the fluid sample includes directing a gas curtain across the port of the liquid container, operation 854. Other examples for isolating the fluid sample are also depicted herein. Flow continues to operation 856, aligning a port of the liquid container with an OPI. In particular examples, the method 850 includes penetrating the port with the OPI, operation 858, and/or sealingly engaging the port with the OPI, operation 860. Examples of structures that enable both penetration and sealing engagement are depicted herein. In particular examples, sealingly engaging the port with the OPI includes penetrating at least one of a septum or positionable shutter with the OPI, operation 862. Thereafter, the method 850 concludes with operation 864, ejecting the droplet into the OPI while maintaining the isolation of the fluid sample.

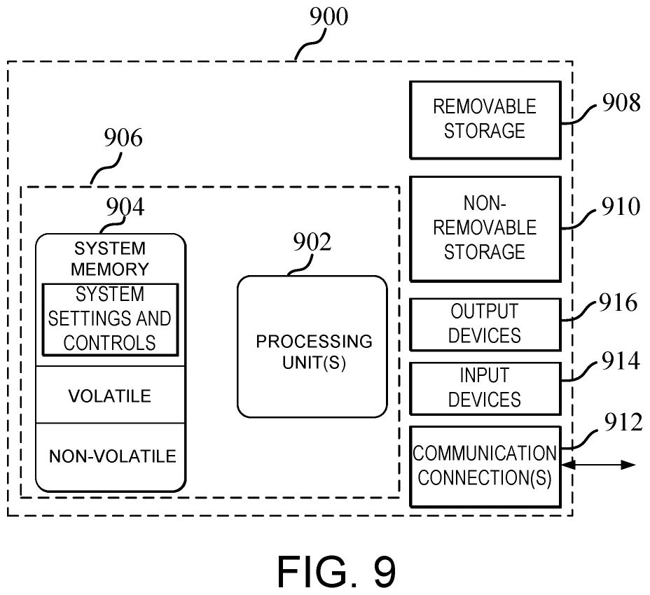

FIG. 9 depicts one example of a suitable operating environment 900 in which one or more of the present examples can be implemented. This operating environment may be incorporated directly into the controller for a mass spectrometry system, e.g., such as the controller depicted in FIG. 1. This is only one example of a suitable operating environment and is not intended to suggest any limitation as to the scope of use or functionality. Other well-known computing systems, environments, and/or configurations that can be suitable for use include, but are not limited to, personal computers, server computers, hand-held or laptop devices, multiprocessor systems, microprocessor-based systems, programmable consumer electronics such as smart phones, network PCs, minicomputers, mainframe computers, tablets, distributed computing environments that include any of the above systems or devices, and the like.

In its most basic configuration, operating environment 900 typically includes at least one processing unit 902 and memory 904. Depending on the exact configuration and type of computing device, memory 904 (storing, among other things, instructions to control the eject the samples, actuate the OPI, activate a curtain gas or open a shutter, or perform other methods disclosed herein) can be volatile (such as RAM), non-volatile (such as ROM, flash memory, etc.), or some combination of the two. This most basic configuration is illustrated in FIG. 9 by dashed line 906. Further, environment 900 can also include storage devices (removable, 908, and/or non-removable, 99) including, but not limited to, magnetic or optical disks or tape. Similarly, environment 900 can also have input device(s) 914 such as touch screens, keyboard, mouse, pen, voice input, etc., and/or output device(s) 916 such as a display, speakers, printer, etc. Also included in the environment can be one or more communication connections 912, such as LAN, WAN, point to point, Bluetooth, RF, etc.

Operating environment 900 typically includes at least some form of computer readable media. Computer readable media can be any available media that can be accessed by processing unit 902 or other devices having the operating environment. By way of example, and not limitation, computer readable media can include computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other tangible medium which can be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. A computer-readable device is a hardware device incorporating computer storage media.

The operating environment 900 can be a single computer operating in a networked environment using logical connections to one or more remote computers. The remote computer can be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

In some examples, the components described herein include such modules or instructions executable by computer system 900 that can be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some examples, computer system 900 is part of a network that stores data in remote storage media for use by the computer system 900.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A method of sampling an ejection of a sample from a liquid container, the method comprising:
disposing the liquid container adjacent an open port interface, wherein the container comprises a sampling port;
engaging the open port interface with the sampling port;
ejecting the sample from the liquid container, through the sampling port, and into the open port interface; and
analyzing the sample with a mass spectrometry device.

2. The method of claim 1, wherein engaging the open port interface with the sampling port comprises opening at least one of a shutter or a septum.

3. The method of claim 1, wherein engaging the open port interface with the sampling port comprises receiving the open port interface in the sampling port.

4. The method of claim 1, wherein engaging the open port interface with the sampling port further comprises receiving the open port interface in the liquid container.

5. The method of claim 1, further comprising flowing a curtain gas across the sampling port, prior to engaging the open port interface with the sampling port.

6. The method of claim 1, further comprising ejecting a curtain gas from the sampling port, prior to engaging the open port interface with the sampling port.

7. The method of claim 6, wherein engaging the open port interface with the sampling port comprises aligning the open port interface with the ejected curtain gas.

8. A system for obtaining a sample for analysis, the system comprising:
a liquid container containing the sample;
an open port interface for receiving the sample;
an acoustic ejection device for ejecting a droplet of the sample from the liquid container; and
means for isolating an interior of the liquid container from an atmosphere surrounding the liquid container, wherein the means for isolating is configurable to allow ejection of the droplet from the liquid container and into the open port interface.

9. The system of claim 8, wherein the means comprises a shutter positionable in a first open position and a second closed position.

10. The system of claim 9, wherein the shutter is positionable in the first open position upon engagement of the open port interface with at least a portion of the shutter.

11. The system of claim 8, wherein the means comprises at least one of a septum and a gasket.

12. The system of claim 8, wherein the means comprises a curtain gas ejector directed proximate a sampling port.

13. The system of claim 8, wherein the open port interface is positionable relative to the liquid container.

14. The system of claim 8, wherein the liquid container comprises a conduit, and wherein the sample flows continuously through the liquid container.

15. The system of claim 8, wherein the open port interface is configured to contact the sample.

16. A method of aseptically sampling a droplet of a fluid sample, the method comprising:
isolating, from a surrounding atmosphere, the fluid sample in a liquid container;
aligning a port of the liquid container with an open port interface;
ejecting the droplet into the open port interface while maintaining the isolation of the fluid sample.

17. The method of claim 16, wherein isolating the fluid sample comprises directing a gas curtain across the port of the liquid container.

18. The method of claim 16, further comprising penetrating the port with the open port interface.

19. The method of claim 16, further comprising sealingly engaging the port with the open port interface.

20. The method of claim 19, wherein sealingly engaging the port comprises penetrating at least one of a septum or positionable shutter with the open port interface.
